(19) United States
(12) Patent Application Publication
(10) Pub. No.: US 2023/0144471 A1
(43) Pub. Date: May 11, 2023

(54) MASK ARRANGED TO FLEX ABOUT MEDIAN PLANE

(71) Applicant: HEWLETT-PACKARD DEVELOPMENT COMPANY, L.P., Spring, TX (US)

(72) Inventors: Alfonso Cameno Salinas, Sant Cugat del Valles (ES); Jordi Gorchs Pahisa, Sant Cugat del Valles (ES); Carmen Blasco Cortes, Sant Cugat del Valles (ES); Marc Guillaumet Campmany, Sant Cugat del Valles (ES); Sergio Puigardeu Aramendia, Sant Cugat del Valles (ES); Clara Remacha Corbalan, Sant Cugat del Valles (ES); Andreu Oliver Gonzalez, Sant Cugat del Valles (ES); Arturo Garcia Gomez, Sant Cugat del Valles (ES)

(21) Appl. No.: 17/997,495

(22) PCT Filed: May 22, 2020
(86) PCT No.: PCT/US20/34150

§ 371 Date: Oct. 28, 2022

(51) Int. Cl. A62B 23/02; A41D 13/11; B33Y 80/00

(52) U.S. Cl. CPC A62B 23/02; A41D 13/1107; B33Y 80/00; B33Y 10/00

(57) ABSTRACT

A mask is described comprising a mask body for covering the nose and mouth of a wearer, and a cushion for sealing against the wearer's face. The cushion depends inwardly from the periphery of the mask body. The mask body and the cushion are formed of an elastomeric material, and the mask body is shaped such that, when the mask is worn by the wearer, the mask body flexes about a median plane.

### BACKGROUND

A mask may cover the nose and mouth of a wearer in order to protect the wearer from potential contaminants in the air.

### BRIEF DESCRIPTION OF THE DRAWINGS

FIG. 1 is a front view of an example mask;

FIG. 2 is a rear view of the mask;

FIG. 3 is a side view of the mask;

FIG. 4 is a cross-sectional view through the mask;

FIG. 5 is a plan view of the mask worn on different wearers; and

FIG. 6 is a flowchart of an example method for manufacturing the mask.

### DETAILED DESCRIPTION

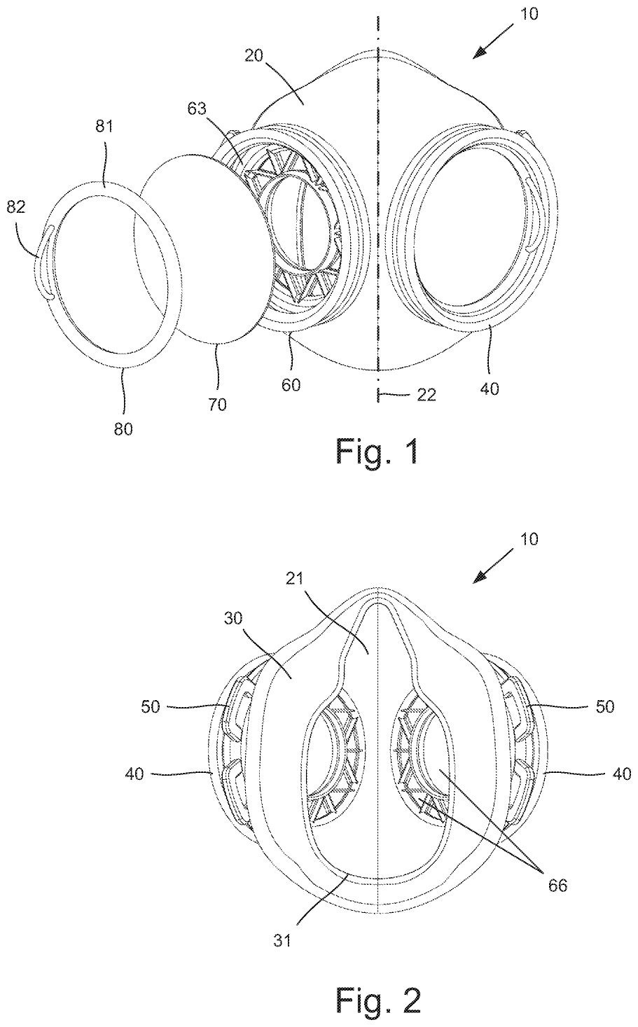

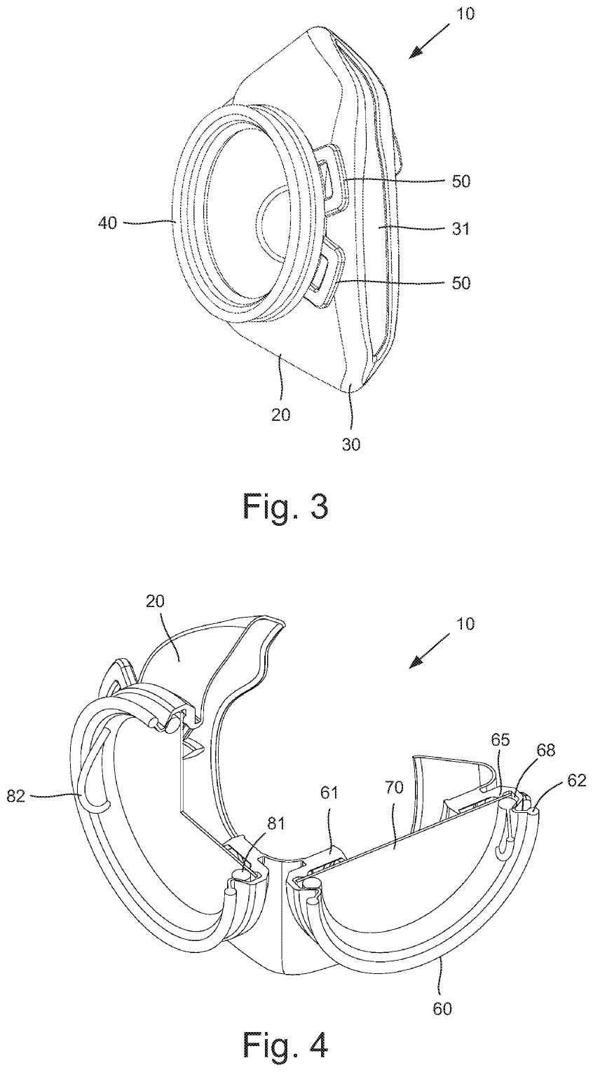

FIGS. 1 to 4 show an example of a mask 10. The mask 10 comprises a mask body 20, a cushion 30, a pair of filter units 40, and attachments 50.

The mask body 20 is generally cup shaped and is intended to cover the nose and mouth of a wearer of the mask. The mask body 20 defines an internal cavity 21 into which the nose and mouth of the wearer are received. The mask body is formed of a compliant elastomeric material, such as a thermoplastic polyurethane (TPU). As described below, the mask body is shaped so as to flex about a median plane 22 when the mask 10 is worn by the wearer.

The cushion 30 is secured to and depends inwardly from the periphery of the mask body 20. The cushion 30 provides a seal against the face of the wearer and comprises an opening 31 through which the nose and mouth of the wearer pass. Like that of the mask body 20, the cushion 30 is formed of a compliant elastomeric material. In one example, the mask body 20 and the cushion 30 may be formed from the same material in the same process to create an integral article.

The filter units 40 are provided on opposite sides of the mask body 20 on either side of the median plane 22. Each filter unit 40 comprises, in an assembled configuration, a filter port 60, a filter medium 70, and a retainer 80.

The filter port 60 forms an opening in the mask body 20, and comprises a base 61 and a side wall 62. The base 61 and side wall 62 collectively define a recess 63 within which the filter medium 70 and the retainer 80 are removably received. The base 61 serves to support the filter medium 70 and comprises an annular ridge 65 and plurality of openings 66. The side wall 62 comprises an annular groove 68 into which the retainer 80 is removably seated.

The retainer 80 comprises an annular ring 81 and a tab 82. When seated within the groove 68 of the filter port 60, the annular ring 81 of the retainer 80 and the annular ridge 65 of the base 61 cooperate to sealingly engage the filter medium 70. The retainer 80 has a relatively large open area. As a result, the retainer 80 retains the filter medium 70 within the filter port 60 without unduly restricting the flow of air through the filter medium 70.

The filter medium 70 is removable from the filter port 60 for cleaning and/or replacement. In order to remove the filter medium 70, the retainer 80 is first removed from the filter port 60 by grasping and pulling the tab 82, after which the filter medium 70 may be removed. The particular choice of filter medium 70 (e.g. material and grade) may be selected according to the intended use of the mask 10. In one example, the filter medium may comprise a non-woven polypropylene fabric. However, other filter media suitable for respiratory filtering may be used, such as polyester, nylon, cellulose or cotton.

The filter port 60 may be formed of a compliant elastomeric material. Furthermore, the groove 68 in the side wall 62 of the filter port 60 may be sized such that, when the retainer 80 is seated within the groove 68, the side wall 62 biases the retainer 80 downwards towards the filter medium 70 and base 61. As a result, an effective seal may be formed between the filter port 60, the filter medium 70, and the retainer 80.

The retainer 80 may be formed of a compliant elastomeric material. This may then make insertion and removal of the retainer 80 easier. For example, the retainer 80 may be squeezed during insertion in order to fit the annular ring 81 within the groove 68.

Each filter unit 40 provides for both inhalation and exhalation. In particular, air inhaled by the wearer is drawn through the filter medium 70, through the openings 66 in the base 61 of the filter port 60, and into the internal cavity 21 of the mask body 20. Air exhaled by the wearer into the internal cavity 21 of the mask body 20 is expelled through the openings 66 in the base 61 of the filter port 60, and through the filter medium 70. The mask 10 therefore provides for filtration of both inhaled and exhaled air.

Attachments 50 are provided on both sides of the mask 10 for attaching a harness (not shown) to the mask 10. The attachments 50 are provided on the filter ports 60 and may be integrally formed with the filter ports 60. The attachments 50 take the form of loops through which straps of the harness may be inserted. However, other forms of attachment are possible. The mask 10 comprises a pair of attachments 50 on each side of the mask 10. This then enables the mask 10 to be used with a harness having upper and lower straps to more firmly secure the mask to the head of the wearer. Alternatively, the mask 10 may be used with a harness having left and right straps for securing around the ears of the wearer. The mask 10 may nevertheless comprise a fewer or greater number of attachments.

The mask body 20 is formed of a compliant, elastomeric material and is shaped such that, when the mask 10 is worn by the wearer, the mask body 20 may flex about a median plane 22 of the mask body 20.

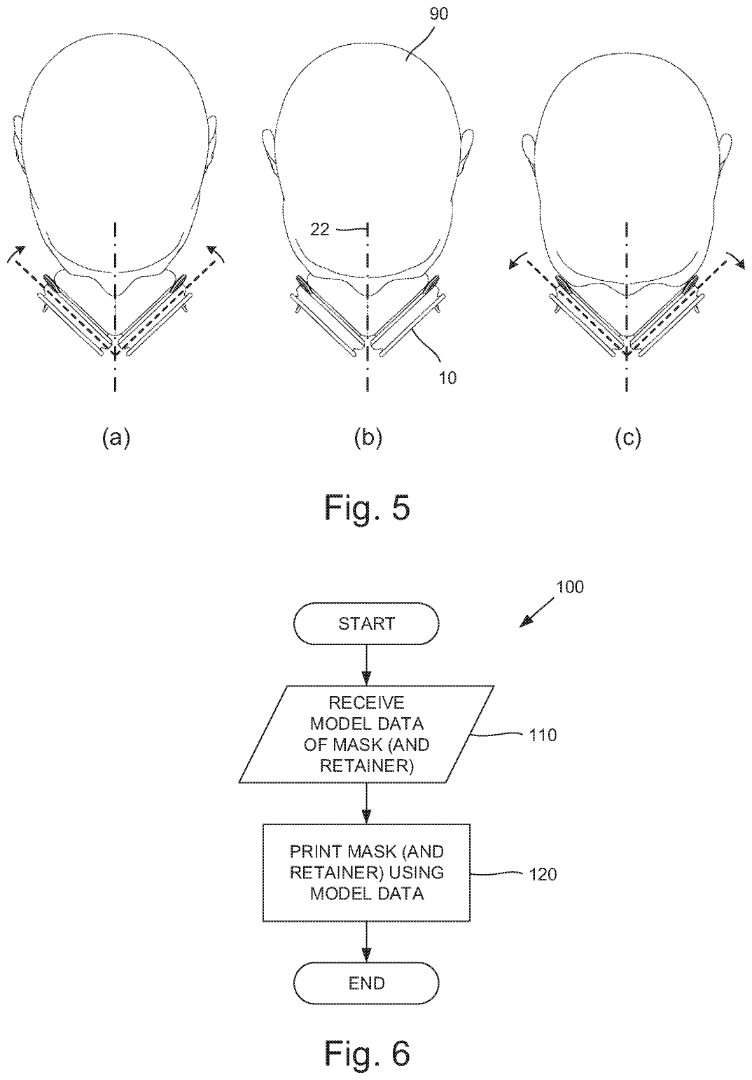

FIG. 5 illustrates the mask 10 when worn by a wearer 90 having (a) a long/narrow facial profile, (b) a medium facial profile, and (c) a short/wide facial profile, as set out in international standard ISO/TS 16976-2. When the mask 10 is placed against the face of a wearer 90 having a medium facial profile, little or no flex in the mask body 20 occurs. However, when the mask 10 is placed against the face of a wearer 90 having a long/narrow profile, and tension is applied to the sides of the mask 10 (e.g. by the harness), the two sides of the mask body 20 flex inwards about the median plane 22. Conversely, when the mask 10 is placed against the face of a wearer 90 having a short/wide profile, the two sides of the mask body 20 flex outwards about the median plane 22. The mask body 20 therefore flexes about the median plane by different amounts or angles when worn by wearers having different facial profiles. By flexing about the median plane 22 in response to changes in the facial shape or profile of the wearer 90, the cushion 30 is able to better conform to the shape of the face and thus a more effective seal may be formed between the mask 10 and the wearer 90. The flexion of the mask body 20 in conjunction with the deformation of the cushion 30 enables a single design of mask 10 to fit a wide range of face profiles, thereby providing a good level of sealing between the mask 10 and wearer 90.

The filter ports 60 are generally stiffer than the mask body 20 owing to their geometry, even when formed of the same elastomeric material as that of the mask body 20. By providing the filter ports 60 on opposites sides of the mask body 20 (i.e. on opposite sides of the median plane 22), the filter ports 60 provide increased stiffness to the sides of the mask body 20. As a result, when tension is applied to the sides of the mask 20 (e.g. by the harness), the mask body 20 is more likely to flex about the median plane 22.

The attachments 50 are provided on the filter ports 60 but could alternatively be provided on the mask body 20. If the attachments 50 are provided on the mask body 20, the tension created by the harness may cause the mask body 20 to deform locally and pull the cushion 30 away from the wearer's face. The filter ports 60, as already noted, are generally stiffer than the mask body 20. Accordingly, by providing the attachments 50 on the filter ports 60, the tension applied to the mask 10 by the harness is less likely to pull the cushion 30 away the from the face of the wearer.

The mask 10 comprises a pair of filter units 40, each of which provides for both inhalation and exhalation. By providing two filter units 40, a relatively large filter area may be achieved through which the wearer is able to inhale and exhale. As a result, breathing may be made easier, i.e. less restrictive. Nevertheless, the mask 10 may comprise a single (potentially larger) filter unit on one side of the mask body 20. The single filter unit may again provide for both inhalation and exhalation. Alternatively, the filter unit may provide for just one of inhalation and exhalation, and the mask 10 may comprise a one-way valve (perhaps seated within the other filter port) to provide for the other of inhalation and exhalation. This particular configuration may be desirable when the mask 10 filters only one of inhaled air and exhaled air, but not both. Where the mask 10 comprises a single filter unit, the filter unit (and any one-way valves) continues to be provided on a side of the mask body 20, such that flexing of the mask body 20 about the medial plane 22 is unimpeded.

Two or more of the components of the mask 10 may be integrally formed, which is to say that the components may be formed as a unitary structure from the same material. For example, the mask body 20 and the cushion 30 may be integrally formed. Additionally or alternatively, the mask body 20 may be integrally formed with the filter ports 40. Indeed, the mask 10 may be formed as a single unitary structure. That is to say that the mask body 20, cushion 30, filter ports 40 and attachments 50 may be integrally formed. By integrally forming components, and in particular by forming the mask 10 as a single unitary structure, gaps and grooves between different components may be avoided, which might otherwise harbor contaminants, such as bacteria and viruses, or which may create challenges to achieve appropriate sealing. As a result, a potentially more hygienic mask may be realized, which is easier is to clean and sterilize. Additionally, manufacture of the mask 10 (e.g. using injection molding, compression molding and additive manufacturing) may be made without assembly of multiple mask components.

FIG. 6 illustrates an example method 100 for manufacturing the mask 10. In this method 100, the mask 10 is manufactured as a single unitary structure using 3D printing. The method 100 comprises receiving 110 at a 3D printing device model data for the mask 10, and printing 120 the mask 10 using the model data with the 3D printing device. The 3D printing device then prints the mask 10 from an elastomeric material, such as TPU. In one example, the mask body may be formed from Ultrasint® TPU01 available from BASF 3D Printing Solutions GmbH.

Where the retainers 80 are formed of the same elastomeric material as the mask 10, both the mask 10 and the retainers 80 may be printed in a single print job. In this instance, the 3D printing device may receive 110 model data for both the mask 10 and the retainers 80, and then print 120 the mask 10 and the retainers 80 simultaneously. Furthermore, the 3D printing device may receive model data for a harness for use with the mask 10, which may be printed separately or simultaneously with the mask 10.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A mask comprising:
a mask body for covering the nose and mouth of a wearer; and
a cushion for sealing against the wearer's face, the cushion depending inwardly from the periphery of the mask body,
wherein the mask body and the cushion are formed of an elastomeric material, and the mask body is shaped such that, when the mask is worn by the wearer, the mask body may flex about a median plane.

2. A mask as claimed in claim 1, wherein the mask body and the cushion are integrally formed.

3. A mask as claimed in claim 1, wherein the mask comprises a filter port provided on a side of the mask body.

4. A mask as claimed in claim 3, wherein the mask comprises a pair of filter ports provided on opposite sides of the mask body.

5. A mask as claimed in claim 3, wherein the filter port and the mask body are integrally formed.

6. A mask as claimed in claim 3, wherein the filter port provides for both inhalation and exhalation.

7. A mask as claimed in claim 3, wherein the filter port comprises a recess for receiving a filter medium and a retainer, the retainer engagable with the filter port to retain the filter medium in a sealed engagement.

8. A mask as claimed in claim 7, wherein the retainer is formed of an elastomeric material.

9. A mask as claimed in claim 7, wherein the filter port comprises an annular groove, and the retainer comprises an annular ring removably received within the groove.

10. A mask as claimed in claim 4, wherein the mask comprises attachments for attaching a harness to the mask, the attachments being provided on the filter ports.

11. A mask as claimed in claim 10, wherein the attachments and filter ports are integrally formed.

12. A mask as claimed in claim 1, wherein the mask body may flex about the median plane by different amounts when worn by wearers having different facial profiles.

13. A mask as claimed in claim 1, wherein the mask is formed as a single article by 3D printing.

14. A method comprising:
receiving at a 3D printing device model data for a mask; and
printing the mask with the 3D printing device,
wherein the mask is printed from an elastomeric material and comprises a mask body for covering the nose and mouth of a wearer and a cushion for sealing against the wearer's face, the cushion depending inwardly from the periphery of the mask body, and the mask body being shaped such that, when the mask is worn by a wearer, the mask body may flex about a median plane.

15. A method as claimed in claim 14, wherein the mask comprises a filter port for receiving a filter medium and a retainer, and the method comprises receiving at the 3D printing device model data for the retainer, and printing simultaneously the mask and the retainer with the 3D printing device.
